(19) United States
(12) Patent Application Publication
(10) Pub. No.: US 2026/0181150 A1
(43) Pub. Date: Jun. 25, 2026

(54) ENTROPY CODING HARDWARE FOR MACHINE LEARNING CODECS

(71) Applicant: ADVANCED MICRO DEVICES, INC., Santa Clara, CA (US)

(72) Inventors: Mark Thompson, Cambridge (GB); Momen Kamal Tageldeen Mohammedosman, Cambridge (GB)

(21) Appl. No.: 18/999,894

(22) Filed: Dec. 23, 2024

(51) Int. Cl. H04N 19/13; H04N 19/156; H04N 19/184; H04N 19/436

(52) U.S. Cl. CPC H04N 19/13; H04N 19/156; H04N 19/184; H04N 19/436

(57) ABSTRACT

An apparatus includes first and second circuitry, such as a first memory and a second memory. The first circuitry is configured to store compressed information representing a set of distribution functions associated with a set of entropy models. The second circuitry is configured to store mappings of requests for subsets of the set of distribution functions to one or more offsets in the first circuitry corresponding to the compressed information representing the subsets. The apparatus also includes circuitry that implements the set of entropy models. This circuitry is configured to perform entropy coding based on the subsets and a first entropy model selected from the set of entropy models. This circuitry can include one or more entropy engines that have a set of ports for encoding or decoding one or more streams of bits or symbols. Multiple streams can therefore be encoded or decoded concurrently or in parallel.

### BACKGROUND

The amount of image and video data that is generated, transferred, stored, and consumed is vast and continually increasing. Image and video compression techniques are therefore critical to support the storage, transmission, and display of visual data within the constraints imposed by the capabilities of transmission networks and storage devices. Numerous compression methods have been developed to balance the competing demands for removing unnecessary information from the visual data and maintaining high perceived quality of the images or video produced using the visual data. Conventional image compression techniques perform entropy coding to reduce statistical redundancy within the images, e.g., using Huffman coding, arithmetic coding, and the like. Spatial frequencies in the visual data can be used to further reduce statistical redundancy and improve image compression ratios, e.g., using transform coding such as Discrete Cosine Transform (DCT). Spatial and/or visual redundancy in the images can be reduced using prediction and quantization techniques. Compressing video data also requires considering temporal information and methods such as motion estimation, compensation, and temporal prediction can be used to save time and space.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system that includes hardware for entropy coding used by machine learning (ML) codecs such as neural video codecs, according to some embodiments.

FIG. 2 illustrates an entropy engine that performs entropy coding for ML codecs such as neural video codecs, according to some embodiments.

FIG. 3 illustrates data flow through a system that performs decoding of the bitstream into a set of symbols using an entropy engine, according to some embodiments.

FIG. 4 illustrates encoding of the video frames to form a bitstream using a neural network model in a processing system that includes one or more entropy engines, according to some embodiments.

FIG. 5 illustrates decoding of a bitstream to recover video frames using a neural network model in the processing system shown in FIG. 4, according to some embodiments.

### DETAILED DESCRIPTION

Neural video encoders/decoders (codecs) leverage the power of machine learning (ML) algorithms, which include artificial intelligence (AI) algorithms, to compress image and video data. By training the ML algorithm on massive, labeled datasets of image and video samples, the ML algorithm can significantly improve compression ratios relative to conventional rule-based encoding, while maintaining or improving the perceived visual quality. For example, ML algorithms can identify relevant information in the image/video data for more efficient compression, as well as adapting encoding strategies based on the content, which can further improve compression. The ML algorithms implemented in neural video codecs are typically trained and executed on parallel processing units such as graphics processing units (GPUs) or neural processing units (NPUs). However, neural video codecs (and other codecs) still require entropy coding of the image/video data and entropy coding is a serial process that is typically performed on a serial processing unit such as a central processing unit (CPU). Consequently, entropy coding of the image/video data by the CPU introduces relatively high latency between components and is therefore a major performance bottleneck for neural video codecs. Different neural video codecs can employ different entropy models and the model parameters (or variables) can follow different probability density models, which can be inferred from the model (parametric) or pre-determined (non-parametric).

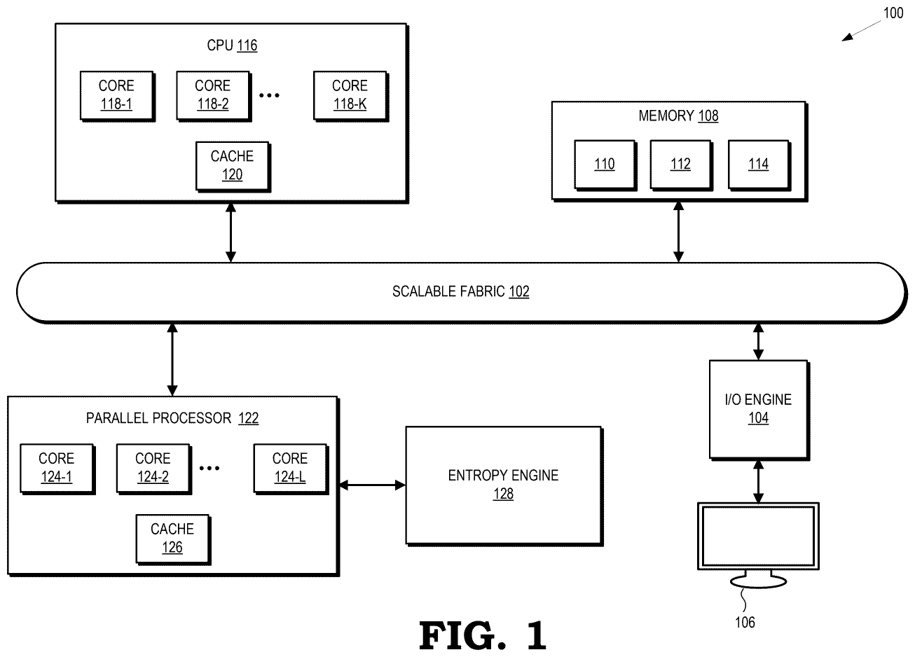

FIGS. 1-5 illustrate systems, apparatuses, and methods of implementing hardware dedicated to entropy coding for encoding of symbols by an ML model into a (compressed) bitstream and decoding the bitstream by the ML model to recover the symbols. The dedicated hardware includes a processing unit (which can be referred to as an entropy engine) configured to perform entropy coding based on a subset of distribution functions selected from a set of distribution functions for a corresponding set of entropy models. The subset is associated with parameters of a first entropy model selected from the set of entropy models. The set of distribution functions can be cumulative distribution functions (CDFs), probability distribution functions (PDFs), parametric distribution functions, non-parametric distribution functions, other forms of distribution functions, or combinations thereof. A first memory is configured to store compressed information representing the set of distribution functions and the second memory is configured to store mappings of requests for distribution functions to offsets of locations in the first memory corresponding to the compressed information representing the requested distribution functions. In some embodiments, at least one of the offsets is associated with more than one of the plurality of distribution functions. A length or a center of a distribution function for a symbol can be inferred by comparing the offset of a distribution function of a (first) symbol with an offset of a distribution function of the next (second) symbol. In some embodiments, the processing unit includes one or more multiplexers configured to select the first entropy model in response to a model selection signal provided to the processing unit. For example, the model selection signal can be generated and provided by a control processor or a neural processor that executes the neural video codec. The model selection signal can be a layer index, a scale of a parametric distribution, an identifier of a parametric distribution, a memory address, and the like.

In operation, the distribution functions are compressed and stored in the first memory prior to initiating inference by the ML model. Some embodiments of the distribution functions are compressed by stripping padding and trailing elements from the distribution functions, removing one or more duplicated distribution functions, and packing a final set of variable-length distribution functions into a portion the first memory. Mappings of keys associated with distribution function to offsets in the first memory are stored in a second memory. Multiple keys can be mapped to a single offset if the duplicate distribution functions are used by multiple parameters or variables of the ML model. The ML model is also loaded into a neural processor prior to initiating inference and, in some cases, concurrently with loading compressed information representing the set of distribution functions into the first memory. The processing unit is configured to perform encoding of symbols and/or decoding of a bitstream based on the first entropy model, e.g., one of the set of entry models indicated by a selection signal received by the processing unit from a control processor or from the neural processor. The ML model then begins running, e.g., on the neural processor, and the processing unit performs entropy coding based on signals received from the ML model. For example, if the processing unit is decoding a bitstream to recover symbols, the processing unit receives an input bitstream and keys (or other distribution function selection information) for distribution functions associated with the input bitstream. The processing unit uses the mapping in the second memory to translate the keys into offsets in the first memory. Based on the offset, the processing unit retrieves the requested distribution functions from the first memory and decompresses the compressed information. The processing unit then determines values of symbols based on the bitstream, the decompressed distribution functions, and the first entropy model. Encoding of symbols received from the ML model to form an encoded bitstream is performed in an analogous manner based on received symbols, decompressed distribution functions, and the first entropy model.

FIG. 1 illustrates a processing system 100 that includes hardware for entropy coding used by ML codecs such as neural video codecs, according to some embodiments. The processing system 100 includes a scalable fabric 102 implemented with circuitry that supports communication between entities implemented in the processing system 100. The scalable fabric 102 can include a control fabric for conveying control signals and a data fabric for conveying data between entities in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with a display 106, as well as other elements of the processing system 100 such as keyboards, mice, printers, external disks, and the like. The I/O engine 104 is coupled to the scalable fabric 102 so that the I/O engine 104 can communicate with other entities in the processing system 100 by exchanging signals over the scalable fabric 102.

Processing system 100 also includes or has access to a memory 108 or other storage component(s) implemented using a non-transitory computer-readable medium such as a dynamic random-access memory (DRAM). However, some embodiments of the memory 108 are implemented using other types of memory including, for example, static random-access memory (SRAM), nonvolatile RAM, and the like. Some embodiments of the memory 108 store information representing instructions such as program code 110 for one or more applications (e.g., graphics applications, compute applications, machine-learning applications), data 112 that is consumed by the program code 110, and results 114 produced by executing the program code 110.

A central processing unit (CPU) 116 is connected to the scalable fabric 102 to communicate with other entities in the processing system 100, such as the memory 108. The CPU 116 implements circuitry for a plurality of processor cores 118-1 . . . K that execute instructions serially, concurrently, or in parallel depending on the application executing on the CPU 116. In some embodiments, one or more of the processor cores 118 operate as single-instruction-multiple-data (SIMD) units that perform the same operation on different data sets concurrently or in parallel. The CPU 116 is configured to execute instructions such as the program code 110 for one or more applications. Examples of applications include memory management applications, graphics applications, compute applications, and machine-learning applications. The CPU 116 can consume data 112 and store information in the memory 108 such as the results 114 of the executed instructions. The CPU 116 also includes local memory such as one or more caches 120. In the illustrated embodiment, the one or more caches 120 are implemented using SRAM, although other types of memory can be used in other embodiments. The caches 120 can include L1, L2, or L3 caches.

Some embodiments of the processing system 100 include a parallel processor 122. The parallel processor 122 can include, for example, a graphics processing unit (GPU), a general-purpose GPU (GPGPU), a neural processing unit (NPU), an intelligence processing unit (IPU), or another vector processor or parallel processor. The parallel processor 122 includes circuitry to implement one or more processor cores 124-1 . . . L that each operate as a compute unit configured to perform one or more operations based on one or more instructions received by the parallel processor 122. Although three processor cores 124 are shown in FIG. 1, more or fewer processor cores 124 can be implemented in other embodiments of the parallel processor 122. The compute units in the processor cores 124 are implemented as circuitry for one or more single-instruction, multiple data (SIMD) units that perform the same operation on different data sets to produce one or more results. The parallel processor 122 also includes local memory such as one or more caches 126 that can be implemented with SRAM or other circuitry. The caches 126 can include L1, L2, or L3 caches.

Some embodiments of the parallel processor 122 are configured to execute codecs such as neural video codecs that use ML algorithms to compress image and video data, e.g., for storage in the memory 108. The ML algorithm can be trained to identify relevant information in the image/video data for more efficient compression, as well as to adapt encoding strategies based on the content, which can further improve compression. The ML algorithms implemented in neural video codecs are typically trained and executed on parallel processing units such as graphics processing units (GPUs), neural processing units (NPU), or intelligent processing units (IPU). In some implementations, the ML algorithms executed on the parallel processor 122, e.g., to perform inference, are also trained using the parallel processor 122. However, the ML algorithms can be trained on other processors that are internal or external to the processing system 100. As discussed herein, neural video codecs (and other codecs) use entropy coding of the image/video data.

The processing system 100 includes an entropy engine 128 configured to perform entropy coding to support encoding of symbols by the ML model into a (compressed) bitstream and decoding the bitstream by the ML model to recover the symbols. Using the entropy engine 128 for entropy coding can improve the performance of the ML model executing on the parallel processor 122. In the illustrated embodiment, the entropy engine 128 is directly connected to the parallel processor 122, e.g., by one or more wires, cables, or traces. The entropy engine 128 can also be connected to the scalable fabric 102. Some embodiments of the entropy engine 128 include a distribution memory (not shown in FIG. 1 in the interest of clarity) implemented using circuitry for a hierarchical memory system including two memories or portions of memory. For example, a first memory (not shown in FIG. 1 in the interest of clarity) can be configured to store compressed information representing a plurality of distribution functions associated with a plurality of entropy models. A second memory (not shown in FIG. 1 in the interest of clarity) can be configured to store mappings of requests for subsets of the plurality of distribution functions to one or more assets in the first memory that corresponds to the compressed information representing the subsets. The entropy engine 128 also includes circuitry that implements the entropy models and is configured to perform entropy coding based on the subsets and a first entropy model selected from the entropy models.

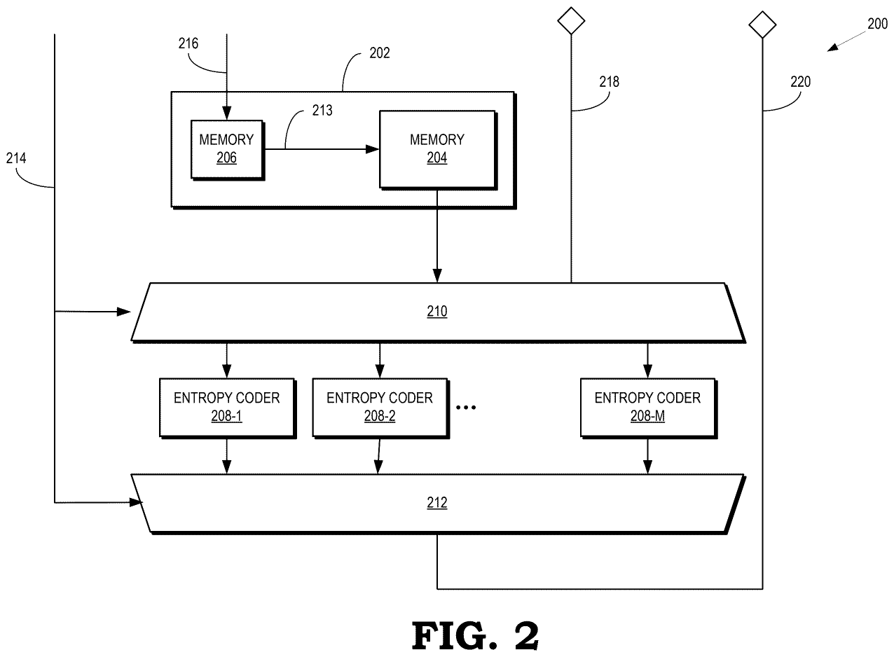

FIG. 2 illustrates an entropy engine 200 that performs entropy coding for ML codecs such as neural video codecs, according to some embodiments. The entropy engine 200 is used to implement some embodiments of the entropy engine 128 shown in FIG. 1. Some embodiments of the entropy engine 200 are configured to support hardware acceleration, as well as providing performance, area, and power benefits for deployments of neural video codec inference. For example, the entropy engine 200 can accelerate inference performed by neural video codecs executing on the parallel processor 122 shown in FIG. 1.

The entropy engine 200 includes a distribution memory 202 formed using circuitry configured to implement two memories 204, 206. Although two memories 204, 206 are shown in FIG. 2, some embodiments of the distribution memory 202 can include more or fewer memories that implement corresponding compression schemes. The (first) memory 204 is configured to store compressed information representing distribution functions that are associated with parameters or variables of different distribution functions. Examples of the different distribution functions include, but are not limited to, cumulative distribution functions (CDFs), probability distribution functions (PDFs), parametric distribution functions, non-parametric distribution functions, other distribution functions, or combinations thereof. Some embodiments of the distribution functions are compressed by stripping padding and trailing elements from the distribution functions, removing one or more duplicated distribution functions, and packing a final set of variable-length distribution functions into a portion the memory 204.

The (second) memory 206 is configured to store mappings of requests for subsets of the plurality of distribution functions to one or more offsets in the memory 204. The offsets indicate locations in the memory 204 of the compressed information representing the requested subsets. The requests can be represented as keys that are received in signaling from the ML model, either directly or via an intermediate or shared memory. In some embodiments, multiple keys can be mapped to a single offset if the corresponding distribution functions are used by multiple parameters or variables of the ML model. For example, requests or keys for distribution functions of multiple parameters or variables can be mapped to the same offset if the multiple parameters or variables are characterized by the same distribution function. Duplicate representations of the same distribution function are therefore removed, which further reduces the size of the compressed representation of the set of distribution functions. A length or a center of a distribution function for a symbol can be inferred by comparing the offset of a distribution function of a (first) symbol in the first memory 204 with an offset of a distribution function of the next (second) symbol in the first memory 204.

Although the memory 204 is used to store the compressed information representative of the distribution functions and the memory 206 is used to store mappings to the compressed information, some embodiments of the entropy engine 200 include circuitry that is configured to store the compressed information, the mappings, or a combination thereof instead of using portions of a memory elements such as the distribution memory 202 or the memory 108 shown in FIG. 1. For example, first circuitry can be used to store the compressed information representative of the distribution functions, and second circuitry can be used to store the mappings to the compressed information.

The distribution functions are compressed and stored in the memory 206 prior to initiating inference by the ML model, e.g., by an ML model executing on the parallel processor 122 shown in FIG. 1. In some embodiments, the compressed set of distribution functions is constructed and loaded prior to or concurrently with loading the ML model or hardware initialization. The distribution functions are associated with the ML model and/or codec such as a neural video codec. As discussed herein, the distribution functions can be parametric or non-parametric. Parametric distribution functions are represented by distribution types and ranges of parameter values that are specified by the ML model. For example, the ML model can specify a Gaussian distribution for a model parameter with a scale value ranging from 0.05 to 200. Non-parametric distribution functions are represented by weights and layer information that are used to construct the distribution functions. The ML model can infer the values of the weights and layer information during inference. The non-parametric distribution functions can also be fixed, determined, or set by a specification or otherwise created during the model setup process, e.g. from frame-level information used to configure the ML model. Some embodiments of neural video codecs implement different models that are associated with different types or combinations of types of distribution functions. Adaptive coding schemes can update one or more of the distribution functions associated with one or more parameters, variables, or encoding models between model steps. New or modified probability distributions can be loaded or adapted between frames or model steps.

The entropy engine 200 also includes circuitry that implements a set of entropy coders 208-1, 208-2, . . . 208-M that perform entropy coding based on different entropy models and their corresponding distribution functions. For example, the entropy coder 208-1 can implement a Huffman coding algorithm, the entropy coder 208-2 can implement an asymmetrical numeral system (ANS) coding algorithm, and the entropy coder 208-M can implement a variable length entropy coding algorithm that uses fixed variable length codes including shorter codes for more frequent symbols and longer codes for less frequent symbols. In the illustrated embodiment, the entropy engine 200 includes multiplexers 210, 212 that are configured to select one of the entropy coders 208 based on a selection signal. The selected entropy coder 208 performs entropy coding based on a corresponding subset of distribution functions, which is selected based on another selection signal (such as a key) that is provided to the memory 206. In response to receiving this selection signal, the memory 206 provides one or more offsets indicating the requested subset to the memory 204, as indicated by the arrow 213. The requested subset of the distribution functions is then accessed from the corresponding compressed information stored in the memory 204. The compressed information is decompressed and provided to the multiplexer 210.

A set of ports conveys signals to and from the entropy engine 200. The ports include a first port 214 that conveys the selection signal for the entropy coder, a second port 216 that conveys the selection signal for the distribution functions, a third port 218 that conveys symbols used by the ML model, and a fourth port 220 that conveys an encoded bitstream associated with the symbols. The bitstream conveyed via the fourth port 220 can be generated by encoding symbols received by the entropy engine 200 or the bitstream can be decoded to generate symbols that are provided to the ML model. For example, the multiplexers 210, 212 can be configured to convey (via the port 218) information representing one or more symbols to the selected one of the entropy coders 208 for encoding the symbols into the bitstream that is output via the port 220. For another example, the multiplexers 210, 212 can be configured to convey (via the port 220) information representing the bitstream to the selected one of the entropy coders 208 for decoding the bitstream into one or more symbols that are output via the port 218. Some embodiments of the entropy engine 200 include multiple sets of ports that support parallel or concurrent entropy coding, as well as encoding or decoding, of a plurality of symbols or bit streams.

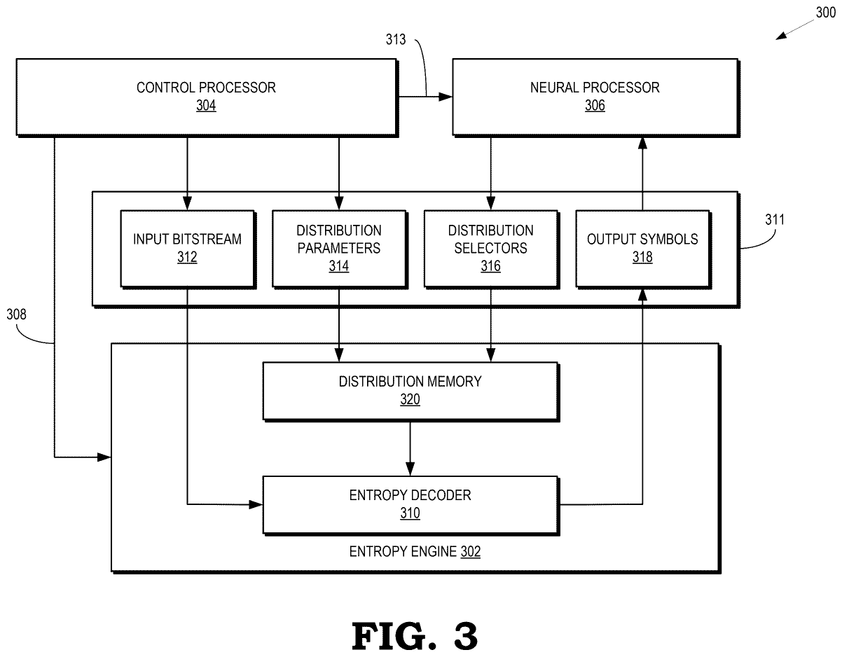

FIG. 3 illustrates data flow through a system 300 that decodes the bitstream into a set of symbols using an entropy engine 302, according to some embodiments. The entropy engine 302 receives the bitstream from a control processor 304 and provides the decoded symbols to a neural processor 306. The control processor 304 can be implemented in a CPU such as the CPU 116 shown in FIG. 1 and the neural processor 306 can be implemented in a parallel processor such as the parallel processor 122 shown in FIG. 1. The entropy engine 302 can be implemented as circuitry configured to perform operations as a separate processing unit such as the entropy engine 128 shown in FIG. 1. However, in other embodiments, two or more of the entropy engine 302, the control processor 304, or the neural processor 306 can be implemented in the same processing unit or circuitry. For example, the entropy engine 302 and the neural processor 306 can be implemented in a parallel processor such as the parallel processor 122 shown in FIG. 1.

During the decoding process, the control processor 304 provides signaling 308 that is used to select one of a plurality of entropy coders from an entropy decoder 310 in the entropy engine 302. The control processor 304 also provides the bitstream to a shared memory 311, which stores the input bitstream in a location 312 that is accessible to the entropy engine 302. The control processor 304 further provides parameters of the distribution functions that are derived from the model configuration prior to or concurrently with loading (as indicated by the arrow 313) the model into the neural processor 306. The shared memory 311 stores the distribution parameters in a location 314 that is accessible to the entropy engine 302. The neural processor 306 provides information used to select one or distribution functions that are used by the selected entropy coder. The shared memory 311 receives this information and stores the distribution selectors in a location 316 that is accessible to the entropy engine 302. The shared memory 311 receives the decoded symbols from the entropy decoder 310 and stores the decoded symbols in a location 318 that is accessible to the entropy engine 302. If the system 300 was performing an encoding process, the flows of the bitstream and the symbols would be reversed so that the neural processor 306 would provide the output symbols to an entropy encoder in the entropy engine 302 and the entropy encoder would provide the encoded bitstream to the control processor 304.

The entropy engine 302 includes a distribution memory 320 such as the distribution memory 202 shown in FIG. 2. The distribution memory 320 includes a hierarchy of two or more memory elements, one of which stores a mapping of the distribution selectors 316 to offsets in the other memory, which stores compressed information representing the distribution functions used by the entropy decoder 310. When the model is running on the neural processor 306, the neural processor 306 writes the distribution selectors to the location 316 in the shared memory 311. For each symbol that is to be decoded, the entropy engine 302 reads the distribution selector from the location 316 and uses the distribution selector to look up the distribution function in the distribution memory 320, as discussed herein. The entropy decoder 310 also reads the input bitstream from the location 312 and then decodes the input bitstream based on the distribution function to determine the value of the next symbol. This value is written back to the location 318 so that the output symbols can be read by the neural processor 306 during the next step of the model. This process iterates for the duration of the bitstream.

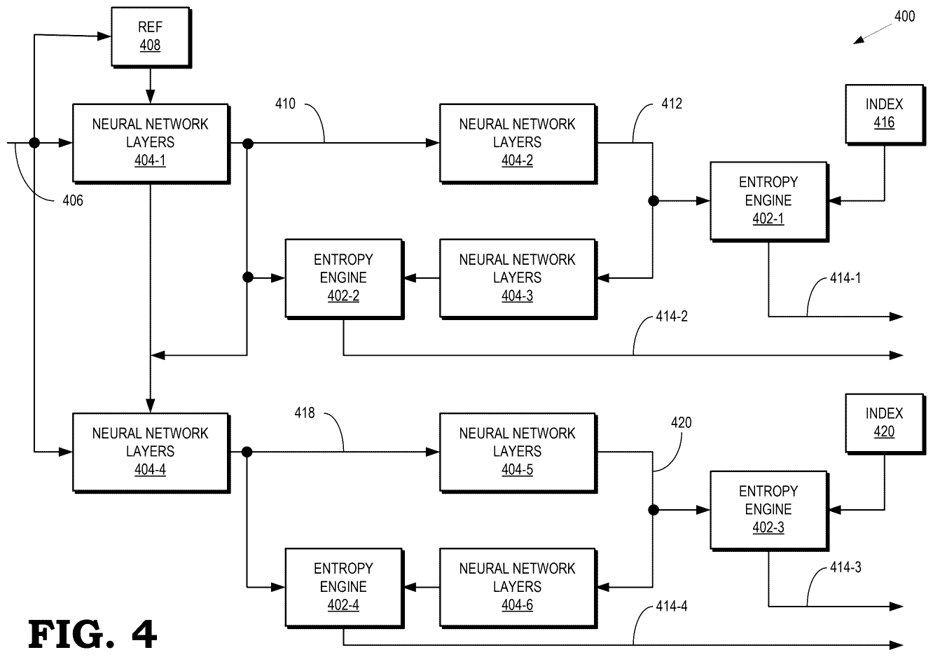

FIG. 4 illustrates encoding of video frames to form a bitstream using a neural network model in a processing system 400 that includes one or more entropy engines 402, according to some embodiments. Some embodiments of the entropy engine(s) are implemented using the entropy engine 128 shown in FIG. 1, the entropy engine 200 shown in FIG. 2, or the entropy engine 302 shown in FIG. 3. The processing system 400 implements circuitry that supports multiple instances of the entropy engine 402, which are indicated by the reference numerals 402-1, 402-2, 402-3, 402-4. The multiple instances of the entropy engine 402 can be instantiated as separate hardware elements or circuits, e.g., different hardware elements or circuits are used to implement the entropy engines 402-1, 402-2, 402-3, 402-4, or as different instances executing on a smaller number of hardware elements or circuits, e.g., as instances that are executing concurrently or in parallel on a single hardware element or circuit. The processing system 400 also implements circuitry for one or more neural network layers 404-1, 404-2, 404-3, 404-4, 404-5, 404-6 of the neural network model. Some embodiments of the neural network layers 404 execute concurrently or in parallel on a parallel processor such as the parallel processor 122 shown in FIG. 1. Each of the neural network layers 404-1, 404-2, 404-3, 404-4, 404-5, 404-6 includes one or more layers of the neural network model.

An input frame 406 is provided to the neural network model by providing the frame to the neural network layers 404-1. A reference frame 408 is also provided to the neural network layers 404-1. In the illustrated embodiment, the reference frame 408 is a previous frame in the video sequence that is being encoded, and the input frame 406 is stored as a reference frame 408 for one or more subsequent input frames. The neural network layers 404-1 infers context information 410 from the input frame 406 and the reference frame 408. Examples of context information include, but are not limited to, motion vectors. The context information 410 is provided to the neural network layers 404-2 and 404-4, as well as the entropy engine 402-2.

In the illustrated embodiment, the neural network layers 404-2 infers a latent or higher-level representation of the context, which is referred to herein as a context hyperprior 412. The neural network layers 404-2 provides the context hyperprior 412 to the neural network layers 404-3. The neural network layers 404-3 uses the context hyperprior 412 to encode the context information 410 to infer a selection signal for a distribution function. For example, the neural network layers 404-3 can infer a value of the selection signal asserted at the second port 216 shown in FIG. 2. The selection signal is provided to the entropy engine 402-2, which selects a probability distribution based on the selection signal. Some embodiments of the neural network layers 404-3 provide multiple selection signals concurrently or in parallel to the entropy engine 402-2 to select multiple distribution functions. The entropy engine 402-2 generates bitstream 414-2 based on symbols in the context information 410 and the selected distribution functions.

The context hyperprior 412 is also sent to the entropy engine 402-1, which generates the bitstream 414-1. In the illustrated embodiment, the entropy engine 402-1 uses a selection scheme based on an index 416 of a channel. For example, the context hyperprior 412 can be represented as a tensor of depth N channels and the index 416 represents a selection signal for the index of one of the channels. Each of the channels corresponds to a non-parametric distribution in the entropy engine 402-1. The selection scheme is determined by the user or the model and the entropy engine 402-1 does not dictate a specific approach. Instead, the entropy engine 402-1 can flexibly support different schemes. The distribution functions in the entropy engine 402-1 (as well as other entropy engines 402) can be updated for each frame or at selected or predetermined model steps.

In the illustrated embodiment, the neural network layers 404-4 generates a latent representation 418 of the input frame 406 based on the reference frame 408, the input frame 406, and the context information 410. The neural network layers 404-5 infers a hyperprior 420, which is passed as a selection signal to the neural network layers 404-6. The selection signal is used to select distribution functions for symbols in the latent representation 418. One or more symbols or selections signals can be passed concurrently or in parallel to the entropy engine 402-4 to generate the bitstream 414-4. The hyperprior 420 is also provided to the entropy engine 402-3, which generates the bitstream 414-3 based on the hyperprior 420 and an index 422 that is provided by a host or model or other source. The bitstreams 414 can be packed into a single bitstream and stored to memory or returned to a host.

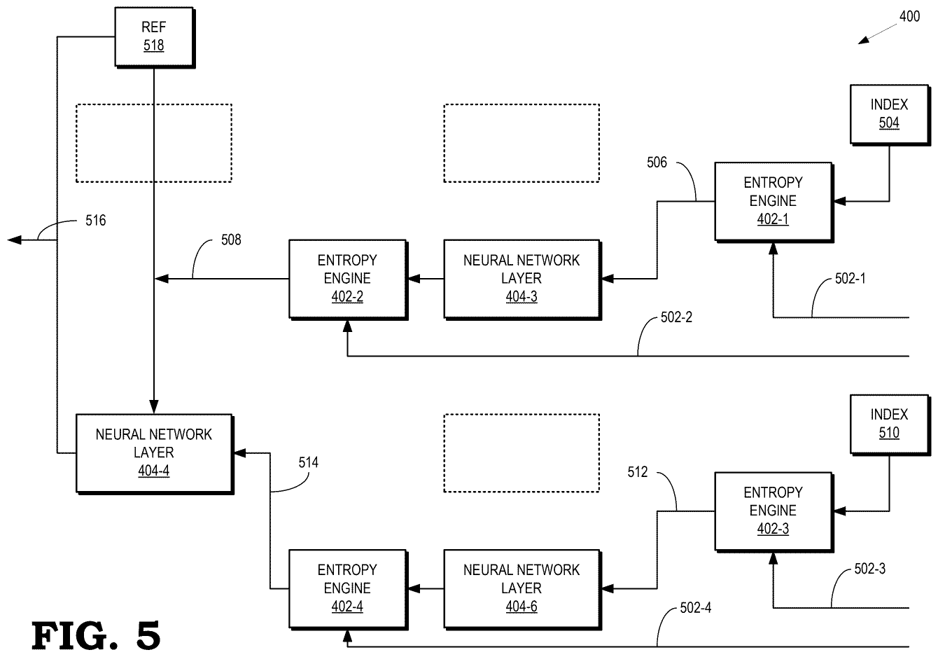

FIG. 5 illustrates decoding of a bitstream to recover video frames using a neural network model in the processing system 400, according to some embodiments. In the illustrated embodiment, a subset of the neural network layers 404 of the neural network model are used to decode the bitstream. The unused neural network layers 404 are shown as dotted line boxes. The direction of the data flow in the processing system 400 shown in FIG. 5 is different from the direction of the data flow shown in FIG. 4.

In the illustrated embodiment, the bitstream 502-1 is fetched and provided to the entropy engine 402-1, which uses the information in the bitstream 502-1 and the index 504 to generate context hyperpriors 506. The neural network layers 404-3 uses the context hyperpriors 506 to infer a selection signal that is provided to the entropy engine 402-2. The entropy engine 402-2 generates context data 508 and/or other information such as one or more motion vectors based on the selection signal and the context hyperpriors 506. The bitstream 502-3 is fetched and provided to the entropy engine 402-3, which uses the information in the bitstream 502-3 and the index 510 to generate hyperpriors 512. The neural network layers 404-6 uses the hyperpriors 512 to infer a selection signal that is provided to the entropy engine 402-4. The entropy engine 402-4 generates a latent representation 514 based on the selection signal and the hyperpriors 512. The neural network layers 404-4 then generates the decoded frame data 516 based on the context data 508 and the latent representation 514. The decoded frame data 516 can also be stored as a reference frame 518 that is used as a reference for decoding subsequent portions of the bitstream 502.

In some embodiments, the apparatus and techniques described above are implemented in a system including one or more integrated circuit (IC) devices (also referred to as integrated circuit packages or microchips), such as the entropy engine described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the embodiments disclosed above may be altered or modified and all such variations are considered within the scope of the disclosed subject matter. Accordingly, the protection sought herein is set forth in the claims below.

What is claimed is:

1. An apparatus comprising:
first circuitry configured to store compressed information representing a plurality of distribution functions associated with a plurality of entropy models;
second circuitry configured to store mappings of requests for subsets of the plurality of distribution functions to at least one offset in the first circuitry corresponding to the compressed information representing the subsets; and
third circuitry configured to implement the plurality of entropy models, the third circuitry being configured to perform entropy coding based on the subsets and a first entropy model selected from the plurality of entropy models.

2. The apparatus of claim 1, wherein the first circuitry comprises a first memory and the second circuitry comprises a second memory.

3. The apparatus of claim 1, wherein the circuitry comprises:
a plurality of entropy coders configured to perform entropy coding based on corresponding ones of the plurality of entropy models; and
at least one multiplexer configured to receive a first signal and select a first entropy coder based on the first signal, the first entropy coder being configured to perform the entropy coding based on the first entropy model and the subset of the plurality of distribution functions.

4. The apparatus of claim 3, wherein the second circuitry is configured to receive a second signal indicating the request for the subset of the plurality of distribution functions and to provide the at least one offset to the first circuitry in response to receiving the second signal, and wherein the first circuitry is configured to provide the compressed information representing the subsets indicated by the at least one offset.

5. The apparatus of claim 4, wherein the at least one multiplexer is configured to convey decompressed information representing the subset and at least one of a symbol or a bitstream to the first entropy coder.

6. The apparatus of claim 5, wherein the at least one multiplexer is configured to convey information representing the symbol to the first entropy coder for encoding the symbol into the bitstream.

7. The apparatus of claim 5, wherein the at least one multiplexer is configured to convey information representing the bitstream to the first entropy coder for decoding the bitstream into the symbol.

8. The apparatus of claim 5, further comprising:
a plurality of ports configured to convey the first signal, the second signal, the symbol, and the bitstream.

9. The apparatus of claim 8, wherein the plurality of ports supports parallel or concurrent entropy coding of a plurality of symbols or bit streams.

10. A method comprising:
receiving, at first circuitry, a request for a subset of a plurality of distribution functions associated with a first entropy model selected from a plurality of entropy models;
providing, from the first circuitry to second circuitry, at least one offset indicating a location of compressed information representing the subset in the second circuitry; and
performing, at third circuitry, entropy coding based on the subsets and the first entropy model.

11. The method of claim 10, further comprising:
receiving, by at least one multiplexer, a first signal;
selecting, using the at least one multiplexer, a first entropy coder from a plurality of entropy coders based on the first signal; and
performing, using the first entropy coder, the entropy coding based on the first entropy model and the subset of the plurality of distribution functions.

12. The method of claim 11 further comprising:
receiving, at the first circuitry, a second signal indicating the request for the subset of the plurality of distribution functions;
providing, from the first circuitry to the second circuitry, the at least one offset in response to receiving the second signal; and
providing, from the second circuitry, the compressed information representing the subsets indicated by the at least one offset.

13. The method of claim 12, further comprising:
conveying, from the at least one multiplexer, decompressed information representing the subset and at least one of a symbol or a bitstream to the first entropy coder.

14. The method of claim 13, further comprising:
conveying, from the at least one multiplexer, information representing the symbol to the first entropy coder for encoding the symbol into the bitstream.

15. The method of claim 13, further comprising:
conveying, from the at least one multiplexer, information representing the bitstream to the first entropy coder for decoding the bitstream into the symbol.

16. The method of claim 10, further comprising:
compressing the plurality of distribution functions; and
storing, in the second circuitry, the compressed information representing the plurality of distribution functions.

17. The method of claim 16, wherein compressing the plurality of distribution functions comprises at least one of stripping padding or trailing elements from the plurality of distribution functions, removing at least one duplicated distribution function, or packing a set of variable-length distribution functions into a portion of the second circuitry.

18. The method of claim 16, further comprising:
storing at least one mapping of keys associated with the plurality of distribution functions to offsets of the plurality of distribution functions.

19. A system comprising:
entropy engine circuitry configured to perform entropy coding based on a selected subset of a plurality of distribution functions stored by the entropy engine circuitry and a selected one of a plurality of entropy models implemented by the entropy engine circuitry;
a control processor configured to provide at least one first signal to the entropy engine circuitry, the at least one first signal indicating the selected one of the plurality of entropy models; and
a neural processor configured to execute a machine learning (ML) model based on information provided by the selected one of the plurality of entropy models and to provide at least one second signal to the entropy engine circuitry, the at least one second signal indicating the selected subset of the plurality of distribution functions.

20. The system of claim 19, further comprising:
at least one memory accessible by the entropy engine circuitry, the control processor, and the neural processor, wherein the at least one memory configured to store information representing at least one of a bitstream, a symbol, a parameter indicating the selected subset of the plurality of distribution functions, or a parameter indicating the selected one of the plurality of entropy models.
